(19) United States
(12) Patent Application Publication
(10) Pub. No.: US 2011/0119152 A1
(43) Pub. Date: May 19, 2011

(54) System, Method And Process For Producing, Mixing, Purchasing And Licensing Music And Layers Thereof Online

(76) Inventor: Emil Jones, Norcross, GA (US)

(21) Appl. No.: 12/946,760

(22) Filed: Nov. 15, 2010

Related U.S. Application Data
(60) Provisional application No. 61/261,351, filed on Nov. 15, 2009.

(51) Int. Cl. G06Q 30/00

(52) U.S. Cl. 705/26.25

(57) ABSTRACT

A method, system and process of purchasing and licensing musical work online by: providing a host website, allowing a member of the site to post music in the most convenient member, allowing a prospective artist to significantly alter the music under a tiered, layered system, and offering up a desired piece of work for either purchasing or licensing. The host website functions as a facilitating record label/mixer/production facility that provided every interested party with necessary information, agreements and the management of said licensing fees.

### CROSS REFERENCE TO RELATED APPLICATIONS

The present application claims priority to U.S. Provisional Patent Application No. 61/261,351 entitled “Producing, Mixing Purchasing and Licensing Music and Layers Thereof Online” filed Nov. 15, 2009, which is hereby incorporated by reference in its entirety.

### TECHNICAL FIELD

This invention relates generally to the purchase and licensing of musical work. More particularly, the present invention is a system and method for parties to exchange musical work on a host website by use of a system that allows a user to significantly adjust posted music to an extent that suits their liking. The system and method accomplishes this objective through the use of a layered system of allowing music to be listened to and ultimately altered to the end user's satisfaction.

### DESCRIPTION OF RELATED ART

The American Society of Composer (ASCAP), Broadcast Music, Inc. (BMI) and the National Music Publisher's Association (NMPA through its licensing subsidiary, Harry Fox Association or HFA) represent virtually all American songwriters and music publishers, in licensing the rights that are necessary for music services to use copyrighted musical works. At present, a person or music group most likely will resort to one of these three licensing bodies in order to receive a license to make use of a musical work.

As a practical matter, limitations are placed on respective parties in terms of their level of individual creativity after becoming signatories to contracts that place restrictions on the use of catalogued songs. As such, both licensed artists and prospective musical talent are hampered due to an antiquated system that fails to allow for the most creative use of a member's covered musical work.

The present system and method solves this problem by allowing for a quick, efficient means and system for allowing musicians, song writers and producers to directly post and receive a license and/or a sublicense to various artists by means of a website. This host website serves as a functional production/mixing/layering service and allows for the purchase and license of musical works and/or layers and/or mixes in either an altered or substantially similar form in relation to its original posting as desired by the licensee. In turn, this effectively provides the best means of encouraging prospective artists/licensees to obtain licenses and take advantage of a wider range of musical works and/or sublayers without fear of infringing another artist's copyright or without the need to inefficiently go directly to a multitude of artist to license and/or produce various layers or parts of a combined work.

### SUMMARY

Briefly described, in a preferred embodiment, the present method and system of allowing for the direct licensing of songs, layers thereof or musical beats on the Internet by artists of the present disclosure overcomes the above-mentioned disadvantages and meets the recognized need for such a method/system of doing business by providing a website, a model encouraging an entity having musical rights to directly post their work on the internet through the website, and allowing for a wide range of members to access and piece-meal or partition songs and ultimately license a portion or layer as desired.

More specifically, the website will categorize songs according to there genre. The music is then further broken down based upon the type of license offered, instrument used, melody, beats, hook length and any other distinguishing factors that promotes ease of use. An artist is given the freedom to set a price for their license, offer samples, or promote their own albums and further capitalize upon their creative freedom.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a flow diagram of an online musical purchasing and licensing in accordance with the principles of the invention.

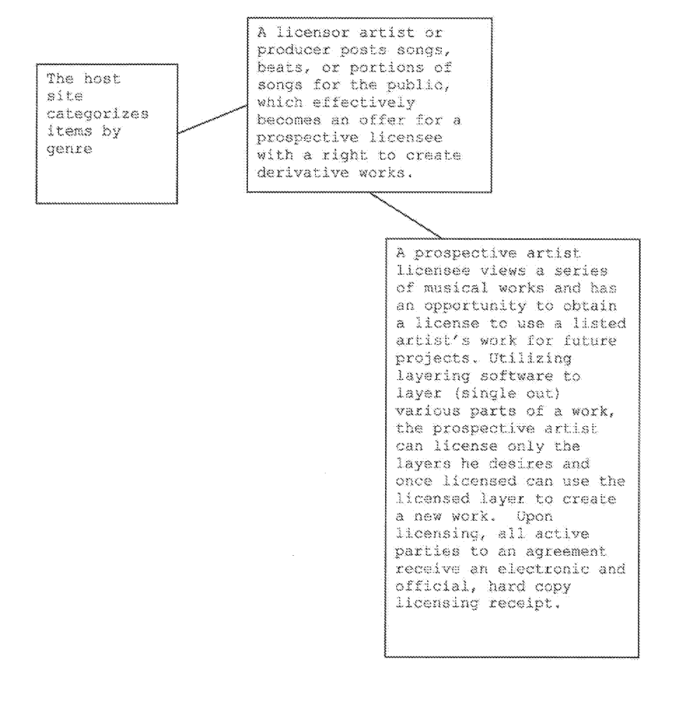

### DETAILED DESCRIPTION OF ILLUSTRATIVE EMBODIMENTS

The method and system of the present invention allows for users to interface across the world via the Internet. The website serves as a conduit for the flow of information between artists falling within a plethora of descriptions. This includes artists seeking to post either samples or complete songs directly on the website along with musicians or producers that desire to advertise their ability to come up with hooks, lines or beats for future licensing. Further an aspiring artist or other talent is allowed to bargain at a distance with a particular artist not just for a complete arrangement but for one or more of any layer which effectively promotes competition, inevitably increases the level of music readily available to the general public, and establishes a competitive market rate for musical compositions or subparts thereof. An artist has the option of creating their own private page, arranging for how their music will be accessed to other members of the website, and once paid is given licensing and bargaining privileges. The website is ideally broken down and categorized by genre, instrumentality, the nature of services desired, and the type of license advertised. Ultimately, the copyright holder remains in control of there music and is afforded the unique opportunity to license as much or little of any their work as they desire without fear of violating a royalty agreement.

More specifically, if an artist or producer (licensee) needs a lead guitar lick for a certain compilation he is producing, he can layer out from a work on the website and then choose only to license the existing lead guitar lick. Additionally, once the licensing fee is paid, the licensee will be able to create derivative works by modifying the licensed piece by adding notes, beats or any other aspects as desired. As part of the agreement to allow the copyright owner to be listed on the website and within the system, the copyright owner consents to allow all or any portion of his work to be licensed and to be modified.

Having thus described exemplary embodiments of the present invention, it should be noted by those skilled in the art that the within disclosures are exemplary only and that various other alternatives, adaptations, and modifications may be made within the scope and spirit of the present invention. Accordingly, the present invention is not limited to the specific embodiments as illustrated herein.

What is claimed:

1. A method and system of performing musical licensing tasks comprising the steps of
a) providing a website;
b) allowing individual artist and groups of artists (Licensors) to post works or subparts of works;
c) allowing artists or others (Licensees) to access said works;
d) providing a means for layering the work;
e) allowing the Licensee the right to pay for a license to the work or any layer of the work;
f) allowing the Licensee the right to modify the work or any layer; and
g) paying a licensing fee to the Licensor for said paid license.
